(19) United States
(12) Patent Application Publication
(10) Pub. No.: US 2009/0083449 A1
(43) Pub. Date: Mar. 26, 2009

(54) Synchronization for Wireless Devices

(75) Inventor: Alex Mashinsky, Memphis, TN (US)

Correspondence Address: COHEN, PONTANI, LIEBERMAN & PAVANE LLP, 551 FIFTH AVENUE, SUITE 1210, NEW YORK, NY, 10176, US

(73) Assignee: Governing Dynamics, LLc, New York, NY (US)

(21) Appl. No.: 11/922,181

(22) PCT Filed: Jun. 19, 2006
(86) PCT No.: PCT/US2006/023768

§ 371 Date: Dec. 13, 2007

Related U.S. Application Data
(60) Provisional application No. 60/691,969, filed on Jun. 17, 2005.

(51) Int. Cl. G06F 3/00

(52) U.S. Cl. 710/8

(57) ABSTRACT

Method for synchronizing configuration files between a primary computer and a wireless device, and then in collaboration with hosted services to obtain access to their remotely located primary computer. In addition, the method provides users of wireless devices, such as wireless displays, keyboards and other peripherals, with the look and feel that they are accustomed to while computing on their own desktop computers. Alternatively, data files are also uploaded to the wireless device, which eliminates the need to remotely access the primary computer. As a result, users are provided with a simple way to transition between multiple different computers without worrying about setting up these computers prior to using them and/or without worrying about erasing or cleaning up files and usage data after each use of the different computers.

### RELATED APPLICATIONS

This application claims priority from U.S. Provisional Patent Application Ser. No. 60/691,969 which was filed on Jun. 17, 2005.

### BACKGROUND OF THE INVENTION

1. Field of the Invention

The present invention generally relates to the field of remote accessing and, more particularly to a method for permitting users to automatically synchronize files via wireless connection with all of the files on their primary computer, as well as other wireless devices such as wireless displays, keyboards and other peripherals.

2. Description of the Related Art

With the wide adoption of the wireless fidelity (WiFi), Bluetooth and UltraWide Band (UWB) standards and the rapid decline of the cost of the chipsets needed to support these standards, a flood of next generation equipment and devices in the residential and commercial markets is expected within the next few years. Such devices typically posses their own user interface, operating systems and manual and remote control, and provide a different user interface and menu option for each device. Such next generation equipment is available which uses Flash memory, hard drives or other storage technology using Universal Serial Bus (USB) wired or wireless connectivity to synchronize communication with electronic devices.

Conventional USB memory stick and miniature hard drives allows users to “synchronize” mobile devices to desktop computers, e.g., to copy files from desktop computers and other devices onto mobile devices so that the files can then be used on other computers. Universal Serial Bus (USB) is a serial bus standard for connecting devices. Radio spectrum-based USB implementation is known as Wireless USB.

One problem associated with synchronization is that it does not allow easy access to all the associated configuration files of a transferred file, such as operating system (OS) settings, hidden files, cookies and security settings to allow these files to also be easily transferred and securely carried along with the “basic” transferred file. Another problem is that most of these associated configuration files are located in folders that are different from the “basic” file and many users are not familiar with their functions or the need to possess them to permit a transparent computing experience at remote locations.

### SUMMARY OF THE INVENTION

The present invention is directed to a method for synchronizing configuration data between a primary computer and a wireless device, and then in collaboration with hosted services to upload configuration data from the wireless device to a remotely located primary computer for accessing data files according to the configuration data. In addition, the system and method provides users of wireless devices, such as wireless displays, keyboards and other peripherals, with the look and feel that they are accustomed to while computing on their own desktop computers. As a result, users are provided with a simple way to transition between multiple different computers without worrying about setting up these computers prior to using them and/or without worrying about erasing or cleaning up files and usage data after each use of the different computers.

Synchronization technology is used in combination with the phones and/or other mobile devices, such as a personal digital assistant (PDA) or wireless enabled personal computer, to provide mobile users with the ability to use any computer or display on an as needed basis. Prior to providing access to the file, a security protocol is initiated and remote authentication is performed to ensure the user is an authorized user to prevent unauthorized access to files and/or content.

Access via a local wireless connection to data files and access via remote authentication is provided by the wireless device, such as a phone, over a high speed or wireless network to a user's desktop computer or remotely hosted files, and access to applications or services to process and share data can be safely performed by the user on any computer or display with a high level of security and control. Thus, the present invention provides a secure computing environment with the required high level of confidence that is needed while allowing the remote accessing of data files.

According to one embodiment, a method is disclosed for permitting access of a data file for use on a local computer based on configuration data of the primary computer. The method is performed by synchronizing a wireless device to the primary computer to upload, to the wireless device, the data configuration files associated with the primary computer and locating a local device in communication with a system. The local device, i.e. a borrowed or rented computer, is remote from the primary device. Upon location of the local computer, the wireless device is notified and an authentication step is performed on the wireless device upon receiving notification that the local computer has been located. The configuration data is then transmitted to the local computer and access is then provided to the data file based on the configuration data if the authentication step is successful.

In an alternative embodiment, the data file is uploaded to the wireless device along with the data configuration files associated with the primary computer. As a result, the user has access to data files without needing to remotely access the primary desktop computer. In another embodiment, access to a data file stored on the primary computer occurs via internet connection between the primary computer and the local computer.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The foregoing and other advantages and features of the invention will become more apparent from the detailed description of the preferred embodiments of the invention given below with reference to the accompanying drawings in which:

FIG. 1 is an exemplary schematic block diagram of the system in accordance with the present invention; and

FIGS. 2(a) and 2(b) is a flow chart illustrating the steps of the method in accordance with the invention.

### DETAILED DESCRIPTION OF THE EXEMPLARY EMBODIMENT

The present invention is directed to a method for synchronizing configuration files between a primary computer and a wireless device, and then in collaboration with hosted services to access and present data files on a local computer according to the configuration files. In addition, the method provides users of wireless devices, such as wireless displays, keyboards and other peripherals, with the look and feel that they are accustomed to while computing on their own desktop computers. Alternatively, the data file is uploaded to the wireless device along with the data configuration files associated with the primary computer, which eliminates the need to remotely access the primary computer. As a result, users are provided with a simple way to transition between multiple different computers without worrying about setting up these computers prior to using them and/or without worrying about erasing or cleaning up files and usage data after each use of the different computers.

In accordance with the present invention, synchronization technology is used in combination with mobile devices, such as a personal digital assistant (PDA) or wireless enabled personal computer or mobile phone, to provide mobile users with the ability to use any computer or display on an as needed basis. Prior to providing access to a requested file, a security protocol is initiated and remote authentication is performed to ensure that the user requesting the file is “authorized”.

In accordance with the invention, access via a local wireless connection to data files and access via remote authentication is provided by the wireless device over a high speed or wireless network to his desktop computer or remotely hosted files, and access to applications or services to process and share data can be safely performed by the user on any computer or display with a high level of security and control.

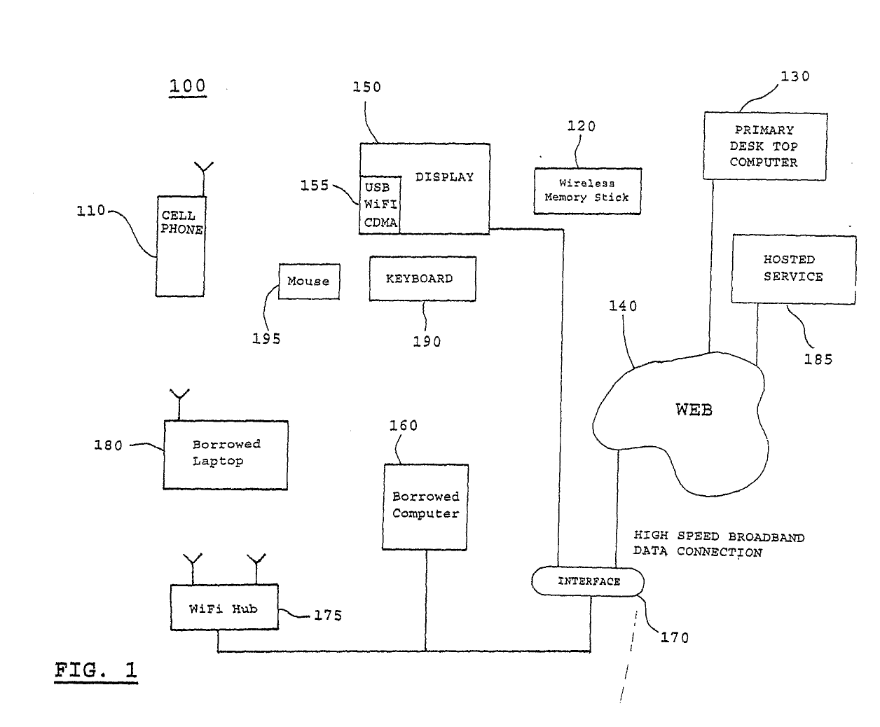

FIG. 1 is an exemplary schematic block diagram of the system 100 in accordance with the present invention. Wireless device 110, such as a phone or a memory stick 120, which each have an embedded flash memory or hard drive (not shown) and support one or multiple wireless communication protocols, such as UltraWide Band (UWB) protocol, Code Division Multiple Access (CDMA), wireless fidelity (WiFi) and the like, interact with different devices via one of the aforementioned protocols to transfer data and authentication information to enable mobile users to thereby access and share information. Although only one phone and one memory stick are shown, it is to be understood that the system may include multiple numbers of each device that are all in use at the same time, and it is not the intention of the present inventor(s) to limit the system 100 to only a single device that performs remote access at any given moment in time.

With additional reference to FIG. 1, the system 100 also includes a primary desktop computer 130, which is typically used to store data files, as well as configuration and security information. However, it should be appreciated that even though the primary desktop computer 130 stores data files, it is possible for these files as well as the configuration and security files to be stored at another location. In one contemplated embodiment, access of remotely located user files is achieved via a server (not shown) that is connected to the user's primary desktop computer 130 via the Internet 140. Alternatively, the data files are uploaded to the wireless device 110 along with the data configuration files associated with the primary computer. Here, the user would have access to his data files without needing to remotely access the primary desktop computer 130.

A display monitor 150 is provided for communicating with a local or borrowed computer 160. The local computer 160 may be connected to the Internet 140 via a high-speed communication port 170 or wireless connection 175.

As shown in FIG. 1, the display monitor may also be connected to the Internet 140 via the high-speed communication port 170 or wireless connection 175. However, it should be appreciated that it is also possible to connect the display monitor 150 to the Internet via other devices, such as a server (not shown). In an embodiment of the invention, the display monitor 150 of the system may be equipped with touch screen features. Here, a menu image or portion of the menu is projected or displayed via thin film or other image display device in a known manner. When a user touches the screen, a window or any surface of such a display, the user instructions that are input as touches or movement on the screen are displayed, and the menu executes pre-programmed options. As a result, the user is permitted to interact with the remote system and its associated components.

An exemplary use of the system 100 is as follows. A user located in one country initially synchronizes his phone 110 with his primary desktop 130 prior to traveling to a foreign nation. The synchronization will copy or move configuration files and, optionally, data files, to the phone. After arriving in the new location, the user would then locate a computing device, e.g., a borrowed computer 160. Once a computing device is located, the user would then use his phone 110 that has been synchronized at to the primary computer 130 to communicate locally with the borrowed computer. Here, the communication is achieved via high-speed wireless connection with the borrowed computer via an internal wireless communication interface 155 utilizing a protocol, such as WiFi, USB or CDMA.

In accordance with the invention, the user utilizes his wireless device to send a command that instructs the borrowed computer 160 to invoke applications and configuration settings that reside locally on the borrowed computer 160 or to request the applications and configuration settings via web services, an Active Server Page (ASP), a hosted service 185 or the users primary desktop computer 130. An ASP is a specification for a dynamically created Web page with a .ASP extension that utilizes ActiveX scripting, which is typically VB Script or Jscript code. When a Web browser requests an ASP, the Web server generates a page with HTML code and sends it back to the browser. ASPs are similar to common gateway interface (CGI) scripts. However, ASPs enable Visual Basic programmers to work with known programming tools.

Upon attempting to invoke the applications that reside on the local or borrowed computer 160, the phone 110 performs authentication. The authentication of the phone is performed using a known manner. One such authentication procedure is described in U.S. Pat. No. 7,050,789, which is incorporated herein in its entirety. It should also be appreciated that authentication also requires the user to enter an access code into his phone, in much the same manner as a password is used to prevent unauthorized access to computing devices. Such a feature protects a user from unauthorized file access in the case that their phone or other wireless device is ever lost.

After authenticating itself to the system 100, the phone 110 transfers resident data, such as the configuration, i.e., operating system (OS) settings, hidden files, cookies and security settings and a transferred file, to the appropriate system (e.g., the borrowed computer 160) to provide the user with the ability to work with the separate display monitor 150 and associated wireless keyboard 190 and mouse 195, in much the same way that the user would normally work on the primary desktop computer 130.

In an embodiment where special access or high security clearance is needed, the wireless device may use broadband wireless network technology, such as CDMA or WiFi, to authenticate and evoke permission to use web services or other programs that are provided on remotely located systems. Here, access via the local wireless connection to data files and/or access via remote authentication are provided by the wireless device over the high speed or wireless network to the user's primary desktop computer 130 or remotely hosted files. As a result, access to applications or services to process and share data can be performed safely on any computer or display with a high level of security and control by the user.

In accordance with the invention, communication between the display monitor 150 and the wireless device is achieved when the wireless device generates a trigger that is initiated by the user or when a nearby device is automatically detected via standard Bluetooth or UWB protocols. Alternatively, if payment for the use of such a display monitor 150 or a computer 160 is needed, such as at a public library, hotel business center or the like, then the wireless devices, the display monitor 150 and computer 160 may perform a predetermined authentication routine, where a prior agreement will have been made to effect payment via a remotely located server (not shown) prior to permitting communication with the display monitor 150.

In an embodiment of the invention, the display monitor 150 functions as a gateway for providing wireless devices with full viewing and typing capabilities, along with a full high-speed wired Internet access or a wireless connection. Here, data stored on the wireless device can be transferred or retrieved as needed, and an interaction with web services and basic applications that reside on the display device or remote computers is also possible.

A combination of at least two of the three elements, for example, the wireless device (e.g. phone 110), memory stick 120, primary desktop computer 130 and the display monitor 150, provide the user with a computing experience that is identical to the computing experience that is achieved when using a primary desktop computer 130. In addition, hardware encryption is provided on the wireless device (e.g., phone 110), and authentication is provided by the combination of the wireless device and the remote systems (e.g. local borrowed computer 160) that the user is authorized to access. As a result, a computing environment having a high level of security, but with a lower level of maintenance is achieved.

If the user deactivates his wireless device or if the wireless device is moved to a location outside a certain distance from the display monitor or the borrowed computer used for such local wireless communications, then all active sessions will be automatically terminated. Here, all traces of the user's data files, including cached files or resident applications, are automatically erased from the local computing device. It should be noted that only user sensitive files, such as data files, are erased. Other files, such as the configuration files associated with the primary computer are permitted to remain on the remote system. As a result, the system can auto-recognize returning users at any associated or interconnected “borrowed computer” because information available from such configuration files can be used by the system to identify returning users or wireless devices.

The system and method of the invention permits the user to always have access to data that is located on the user's wireless device, and the need for a wireless device to have display and keyboard functionalities are eliminated. Naturally, it will be appreciated that the system and method of the invention permits these functions to be provided by any remotely located display monitor or computing device, where these devices provide immediate access to all the user's data stored on the wireless device. As a result, a miniaturized wireless device that costs considerably less than traditional all-in-one organizers or communication devices may be achieved, because the necessary hardware for providing the associated functions is eliminated from the devices.

In an embodiment of the invention, the method provides the capability to accept full menus from devices. In addition, the method also provides the ability to exchange messaging and information between the primary desktop computer 130 and independent wireless devices via the internal wireless communication interface 155.

In an additional embodiment, where new wireless devices enter into the range of the system 100, such as when a user travels to a new location or country, self-discovery and self-configuration of the newly discovered wireless device can be performed. Such a self-configuration is performed based on the wired and wireless communication of all enabled devices between themselves and a central control server (not shown), and the presence or non-presence of configuration data. In an embodiment of the invention, presence monitoring is also performed, where users can walk through rooms of facilities, a home or an office environment and enable or link devices to certain networks or systems based on their rights and access levels as defined in the configuration data, for example. As a result, configuration and maintenance can be performed dynamically and network configuration can also be dynamically created and modified. Consequently, as wireless devices are replaced in the facilities, the user's home or office environment, the devices will be automatically reconfigured and linked with other devices to provide integrated service to the owner of the wireless device.

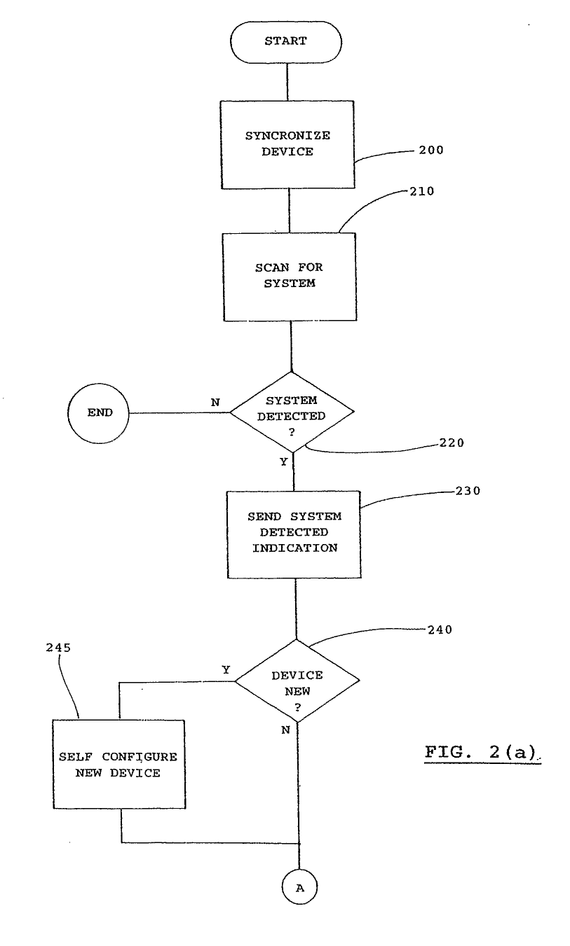

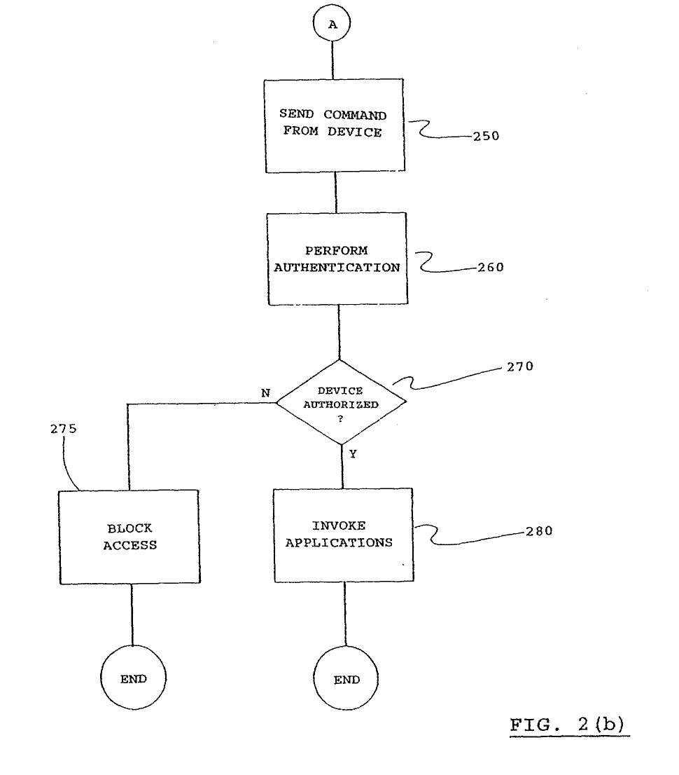

FIGS. 2(a) and 2(b) illustrate the steps of the method of the invention. A user synchronizes a wireless device with the user's primary desktop 130, as indicated in step 200. Next, upon arrival at a remote location, a wireless scan is performed by the wireless device to detect at least one wireless enabled device that is coupled to the system, as indicated in step 210.

A check is then performed to locate at least one borrowed or local computer within the system, as indicated in step 210. If at least one borrowed or local computer cannot be located, then the method is terminated. If a borrowed or local computer is located, then a notification is sent to the wireless device indicating that a local computer has been located, as indicated in step 220.

Next, a check is performed to determine whether the wireless device that has entered the vicinity of the system is a “new” device, i.e., whether the wireless device has ever been used in the system, as indicated in step 240. If the device is new, then a self-configuration of the device is performed, as indicated in step 245.

The user of the wireless device sends a command from the wireless device to instruct the local computer 160 to invoke applications and configuration settings on the local computer, as indicated in step 250. Upon receiving the command, an authentication process is performed to determine whether the wireless device is authorized to access the system 100, as indicated in step 260. If the wireless device is not authorized to access the system, then access is blocked and the method is terminated, as indicated in step 275.

If the wireless device is authorized to access the system 100, then the applications and configuration settings that reside locally on a local computer of the system 100 are invoked, as indicated in step 280. Here, the wireless device transfers configuration data to the system 100 to provide the user with the ability to work on the local computer 160, and to access via the local computer, data files copied from the wireless device or obtained through communication between the local computer and the user's primary computer, as indicated in step 280.

The system and method of the invention eliminates the problems associated with a user needing to access non-public data and services when the user is away from a primary desktop computer. Access via a local wireless connection to data files and access via remote authentication is provided by a wired device over a high speed or wireless network to the user's desktop or hosted files. Alternatively, the data files are uploaded to the wireless device, which eliminates the need to remotely access the data file at the primary desktop computer. Access to applications or services to process and share data can be safely performed by the user on any computer or display monitor in an environment with a high level of security and control. In addition, the method of the invention provides a secure computing environment that provides the required level of confidence associated with remote access of files.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. A method for synchronizing configuration files between a primary computer and a wireless device, comprising the steps of:
synchronizing a wireless device to the primary computer to upload files from the primary computer to the wireless device;
locating a local device in communication with a system, said local device being remote from the primary device;
notifying the wireless device upon location of the local computer;
authenticating the wireless device upon receiving notification that the local computer has been located;
transmitting at least the configuration data to the local computer; and
accessing data files via the local computer based on the configuration data if the authentication step is successful.

2. The method of claim 1, further comprising the steps of:
determining whether the wireless device is a new device; and
self-configuring the wireless device if said device is new.

3. The method of claim 2, wherein said determining step comprises checking to determine presence of configuration data.

4. The method of claim 1, further comprising the step of:
preventing access to the system if the authentication step is not successful.

5. The method of claim 1, further comprising the step of:
transmitting a command from the wireless device to the local computer to invoke applications and configuration settings that reside on the local computer.

6. The method of claim 1, wherein said transmitting step includes the step of:
invoking applications and configurations of the primary computer on the local computer.

7. The method of claim 1, wherein said configuration data comprises at least one of operating system settings, hidden files, cookies and security settings.

8. The method of claim 1, wherein the wireless device comprises a phone or a memory stick.

9. The method of claim 8, wherein the phone and the wireless memory stick include at least one of embedded flash memory or a hard drive.

10. The method of claim 9, wherein the phone and the memory stick each support one or multiple wireless communication protocols.

11. The method of claim 10, wherein the multiple wireless communication protocols comprise at least one of UWB, CDMA and WiFi.

12. The method of claim 1, wherein said notifying step comprises sending a notification from the local device to the wireless device.

13. The method of claim 1, wherein said locating step is performed by the wireless device.

14. The method of claim 1, wherein said uploaded file comprises data files and configuration data.

15. The method of claim 12, wherein said configuration data comprises at least one of operating system settings, hidden files, cookies and security settings.

16. The method of claim 1, further comprising the step of:
transmitting data files to the local computer if the authentication step is successful.

17. The method of claim 1, wherein said local device is in communication with the primary computer via the Internet.
